(19) United States
(12) Patent Application Publication
(10) Pub. No.: US 2023/0084642 A1
(43) Pub. Date: Mar. 16, 2023

(54) ROUTING MESSAGES THROUGH A SECURE MESSAGING PLATFORM

(71) Applicant: WhatsApp LLC, Menlo Park, CA (US)

(72) Inventors: Uzma Hussain Barlaskar, Berkeley, CA (US); Vashist Avadhanula, Sunnyvale, CA (US); Nicolas Emilio Stier Moses, Palo Alto, CA (US); Eduardo Augusto Ribas, Mountain View, CA (US); Raman Papeka, Newark, CA (US)

(21) Appl. No.: 17/939,853

(22) Filed: Sep. 7, 2022

Related U.S. Application Data
(60) Provisional application No. 63/243,640, filed on Sep. 13, 2021.

(51) Int. Cl. H04L 51/04; H04L 51/58; H04L 51/23

(52) U.S. Cl. CPC H04L 51/04; H04L 51/58; H04L 51/23

(57) ABSTRACT

Methods, systems, and storage media for routing messages through a secure messaging platform are disclosed. Exemplary implementations may: receive, at a smart router, a request to send a message to at least one recipient; route, via the smart router, the request to a marketplace of delivery aggregators; select at least one of the delivery aggregators for handling the request; and deliver, via the selected at least one delivery aggregator, the message to the at least one recipient.

### CROSS-REFERENCE TO RELATED APPLICATIONS

This present application claims the benefit of priority under 35 U.S.C. § 119(e) to U.S. Provisional Application No. 63/243,640, filed Sep. 13, 2021, the disclosure of which is hereby incorporated by reference in its entirety for all purposes.

### TECHNICAL FIELD

The present disclosure generally relates to message-based communications, and more particularly to routing messages through a secure messaging platform.

### BRIEF SUMMARY

One aspect of the present disclosure relates to a method for routing messages through a secure messaging platform. The method may include receiving, at a smart router, a request to send a message to at least one recipient. The method may include routing, via the smart router, the request to a marketplace of delivery aggregators. The method may include selecting at least one of the delivery aggregators for handling the request. The method may include delivering, via the selected at least one delivery aggregator, the message to the at least one recipient.

Another aspect of the present disclosure relates to a system configured for routing messages through a secure messaging platform. The system may include one or more hardware processors configured by machine-readable instructions. The processor(s) may be configured to receive, at a smart router, a request to send a message to at least one recipient. The processor(s) may be configured to route, via the smart router, the request to a marketplace of delivery aggregators. The processor(s) may be configured to select at least one of the delivery aggregators for handling the request. The processor(s) may be configured to deliver, via the selected at least one delivery aggregator, the message to the at least one recipient.

Yet another aspect of the present disclosure relates to a non-transient computer-readable storage medium having instructions embodied thereon, the instructions being executable by one or more processors to perform a method for routing messages through a secure messaging platform. The method may include receiving, at a smart router, a request to send a message to at least one recipient. The method may include routing, via the smart router, the request to a marketplace of delivery aggregators. The method may include selecting at least one of the delivery aggregators for handling the request. The method may include delivering, via the selected at least one delivery aggregator, the message to the at least one recipient.

Still another aspect of the present disclosure relates to a system configured for routing messages through a secure messaging platform. The system may include means for receiving, at a smart router, a request to send a message to at least one recipient. The system may include means for routing, via the smart router, the request to a marketplace of delivery aggregators. The system may include means for selecting at least one of the delivery aggregators for handling the request. The system may include means for delivering, via the selected at least one delivery aggregator, the message to the at least one recipient.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system configured for routing messages through a secure messaging platform, according to certain aspects of the disclosure.

FIG. 2 illustrates an example flow diagram for routing messages through a secure messaging platform, according to certain aspects of the disclosure.

FIG. 3 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Exemplary implementations provide a marketplace for message (e.g., SMS, MMS, etc.) aggregators where message traffic can be switched between aggregators in real time. Some implementations may facilitate process robust against spam attacks. Examples of some implementations may be found in “Multi-Armed Bandits with Cost Subsidy,” by Deeksha Sinha, et al., published in the Proceedings of the 24th International Conference on Artificial Intelligence and Statistics, PMLR 130:3016-3024, 2021 (available at http://proceedings.mlr.press/v130/sinha21a/sinha21a.pdf), the entirety of which is incorporated herein by reference.

Some implementations address a variant of the multi-armed bandit (MAB) problem, MAB with cost subsidy, which models many real-life applications where the learning agent has to pay to select an arm and is concerned about optimizing cumulative costs and rewards. Some implementations address an intelligent message (e.g., SMS, MMS, etc.) routing problem. Some implementations address an audience optimization problem faced by several businesses (especially online platforms). Naive generalizations of existing MAB algorithms (e.g., Upper Confidence Bound and Thompson Sampling) may not perform well for this problem. As such, some implementations establish a fundamental lower bound on the performance of any online learning algorithm for this problem. Some implementations include a variant of explore-then-commit and establish near-optimal regret bounds for this algorithm. Some implementations may include numerical simulations to understand the behavior of a suite of algorithms for various instances and recommend a practical guide to employ different algorithms.

According to some implementations, a smart router may be launched. Messages (e.g., SMS, MMS, etc.) may be sent for verification around the world. Some implementations include competing aggregators. For example, if a user locks themselves out of their account on a social media platform, and/or the user gets a new device (e.g., laptop, Smartphone, etc.) for accessing their account on the social media platform, the user may receive a code by message (e.g., SMS, MMS, etc.) to confirm the user's identity. Some implementations may determine which aggregator to send the message. Different aggregators may have different success rates in different telecom networks (e.g., some aggregators may have poor quality routes or infrastructure outages).

The disclosed system(s) address a problem in traditional message-based communication techniques tied to computer technology, namely, the technical problem of delivering messages on an end-to-end encrypted messaging service cost effectively while ensuring a minimum level of delivery assurance, through the use of various message delivery aggregators. The disclosed system solves this technical problem by providing a solution also rooted in computer technology, namely, by providing for routing messages through a secure messaging platform. The disclosed subject technology further provides improvements to the functioning of the computer itself because it improves processing and efficiency in message-based communications.

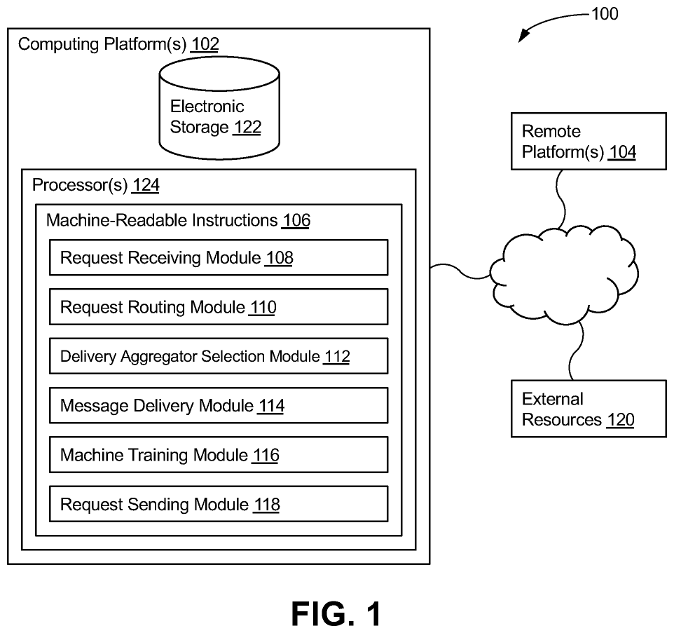

FIG. 1 illustrates a system 100 configured for routing messages through a secure messaging platform, according to certain aspects of the disclosure. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of request receiving module 108, request routing module 110, delivery aggregator selection module 112, message delivery module 114, machine training module 116, request sending module 118, and/or other instruction modules.

Request receiving module 108 may be configured to receive, at a smart router, a request to send a message to at least one recipient. The message may include an SMS message. The message may be sent for verification around the world. The message may be routed to a service provider having a cheapest rate and high efficiency. In some implementations, the secure messaging platform may be end-to-end encrypted.

Request routing module 110 may be configured to route, via the smart router, the request to a marketplace of delivery aggregators. In some implementations, the routing may be based at least in part on a multi-armed bandit selection paradigm. The delivery aggregators may have different success rates in different telecommunications networks.

Delivery aggregator selection module 112 may be configured to select at least one of the delivery aggregators for handling the request. The selecting may be based at least in part on message delivery cost and quality considerations.

Message delivery module 114 may be configured to deliver, via the selected at least one delivery aggregator, the message to the at least one recipient.

Machine training module 116 may be configured to train a machine learning algorithm to select the delivery aggregator.

Request sending module 118 may be configured to send the request to the selected at least one delivery aggregator.

In some implementations, computing platform(s) 102, remote platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 120 may be operatively linked via some other communication media.

A given remote platform 104 may include one or more processors configured to execute computer program modules. The computer program modules may be configured to enable an expert or user associated with the given remote platform 104 to interface with system 100 and/or external resources 120, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Computing platform(s) 102 may include electronic storage 122, one or more processors 124, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 122 may comprise non-transitory storage media that electronically stores information. The electronic storage media of electronic storage 122 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from computing platform(s) 102, information received from remote platform(s) 104, and/or other information that enables computing platform(s) 102 to function as described herein.

Processor(s) 124 may be configured to provide information processing capabilities in computing platform(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, 116, and/or 118, and/or other modules. Processor(s) 124 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 124 includes multiple processing units, one or more of modules 108, 110, 112, 114, 116, and/or 118 may be implemented remotely from the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 124 may be configured to execute one or more additional modules that may perform some or all of the functionality attributed below to one of modules 108, 110, 112, 114, 116, and/or 118.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

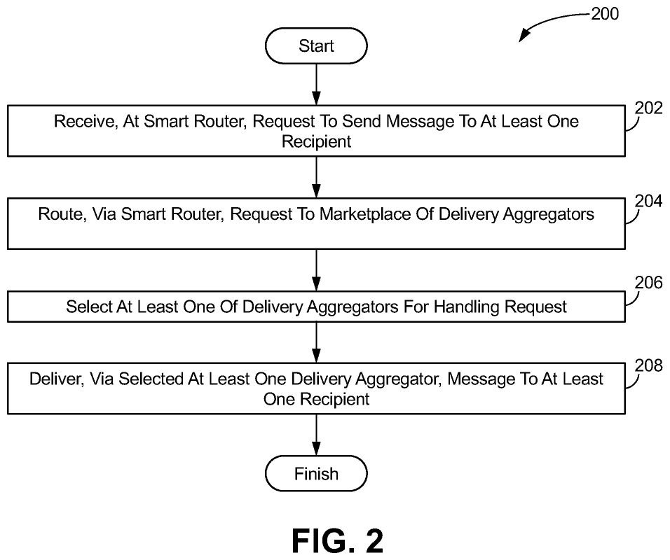

FIG. 2 is an example flow diagram (e.g., process 200) for routing messages through a secure messaging platform, according to certain aspects of the disclosure. For explanatory purposes, the example process 200 is described herein with reference to FIG. 1. Further for explanatory purposes, the steps of the example process 200 are described herein as occurring in serial, or linearly. However, multiple instances of the example process 200 may occur in parallel. For purposes of explanation of the subject technology, the process 200 will be discussed in reference to FIG. 1.

At step 202, the process 200 may include receiving, at a smart router, a request to send a message to at least one recipient. At step 204, the process 200 may include routing, via the smart router, the request to a marketplace of delivery aggregators. At step 206, the process 200 may include selecting at least one of the delivery aggregators for handling the request. At step 208, the process 200 may include delivering, via the selected at least one delivery aggregator, the message to the at least one recipient.

For example, as described above in relation to FIG. 1, at step 202, the process 200 may include receiving, at a smart router, a request to send a message to at least one recipient, through request receiving module 108. At step 204, the process 200 may include routing, via the smart router, the request to a marketplace of delivery aggregators, through request routing module 110. At step 206, the process 200 may include selecting at least one of the delivery aggregators for handling the request, through delivery aggregator selection module 112. At step 208, the process 200 may include delivering, via the selected at least one delivery aggregator, the message to the at least one recipient, through message delivery module 114.

According to an aspect, the message comprises an SMS message.

According to an aspect, the process 200 may include training a machine learning (ML) algorithm to select the delivery aggregator.

According to an aspect, the routing is based at least in part on a multi-armed bandit selection paradigm.

According to an aspect, the selecting is based at least in part on message delivery cost and quality considerations.

According to an aspect, the message is sent for verification around the world.

According to an aspect, the message is routed to a service provider having a cheapest rate and high efficiency.

According to an aspect, the process 200 may include sending the request to the selected at least one delivery aggregator.

According to an aspect, the secure messaging platform is end-to-end encrypted.

According to an aspect, the delivery aggregators have different success rates in different telecommunications networks.

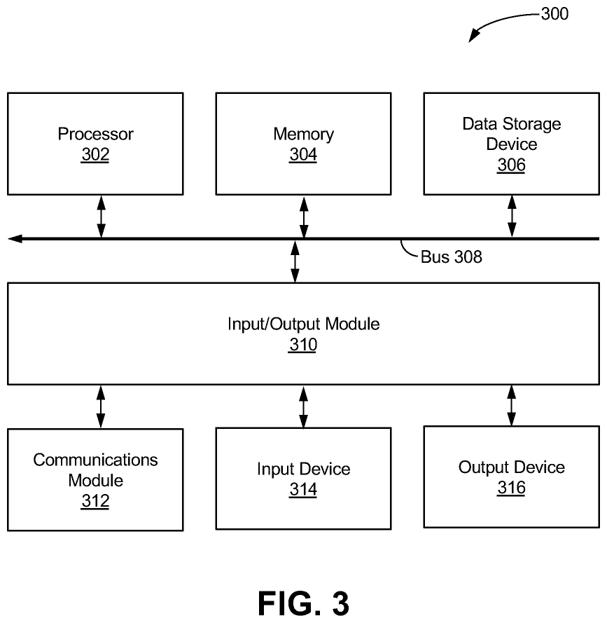

FIG. 3 is a block diagram illustrating an exemplary computer system 300 with which aspects of the subject technology can be implemented. In certain aspects, the computer system 300 may be implemented using hardware or a combination of software and hardware, either in a dedicated server, integrated into another entity, or distributed across multiple entities.

Computer system 300 (e.g., server and/or client) includes a bus 308 or other communication mechanism for communicating information, and a processor 302 coupled with bus 308 for processing information. By way of example, the computer system 300 may be implemented with one or more processors 302. Processor 302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 300 can include, in addition to hardware, code that creates an execution environment for the computer program in question, e.g., code that constitutes processor firmware, a protocol stack, a database management system, an operating system, or a combination of one or more of them stored in an included memory 304, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 308 for storing information and instructions to be executed by processor 302. The processor 302 and the memory 304 can be supplemented by, or incorporated in, special purpose logic circuitry.

The instructions may be stored in the memory 304 and implemented in one or more computer program products, i.e., one or more modules of computer program instructions encoded on a computer-readable medium for execution by, or to control the operation of, the computer system 300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 304 may also be used for storing temporary variable or other intermediate information during execution of instructions to be executed by processor 302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 300 further includes a data storage device 306 such as a magnetic disk or optical disk, coupled to bus 308 for storing information and instructions. Computer system 300 may be coupled via input/output module 310 to various devices. The input/output module 310 can be any input/output module. Exemplary input/output modules 310 include data ports such as USB ports. The input/output module 310 is configured to connect to a communications module 312. Exemplary communications modules 312 include networking interface cards, such as Ethernet cards and modems. In certain aspects, the input/output module 310 is configured to connect to a plurality of devices, such as an input device 314 and/or an output device 316. Exemplary input devices 314 include a keyboard and a pointing device, e.g., a mouse or a trackball, by which a user can provide input to the computer system 300. Other kinds of input devices 314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 316 include display devices such as an LCD (liquid crystal display) monitor, for displaying information to the user.

According to one aspect of the present disclosure, the above-described gaming systems can be implemented using a computer system 300 in response to processor 302 executing one or more sequences of one or more instructions contained in memory 304. Such instructions may be read into memory 304 from another machine-readable medium, such as data storage device 306. Execution of the sequences of instructions contained in the main memory 304 causes processor 302 to perform the process steps described herein. One or more processors in a multi-processing arrangement may also be employed to execute the sequences of instructions contained in memory 304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 300 can include clients and servers. A client and server are generally remote from each other and typically interact through a communication network. The relationship of client and server arises by virtue of computer programs running on the respective computers and having a client-server relationship to each other. Computer system 300 can be, for example, and without limitation, a desktop computer, laptop computer, or tablet computer. Computer system 300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 302 for execution. Such a medium may take many forms, including, but not limited to, non-volatile media, volatile media, and transmission media. Non-volatile media include, for example, optical or magnetic disks, such as data storage device 306. Volatile media include dynamic memory, such as memory 304. Transmission media include coaxial cables, copper wire, and fiber optics, including the wires that comprise bus 308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 300 reads game data and provides a game, information may be read from the game data and stored in a memory device, such as the memory 304. Additionally, data from the memory 304 servers accessed via a network the bus 308, or the data storage 306 may be read and loaded into the memory 304. Although data is described as being found in the memory 304, it will be understood that data does not have to be stored in the memory 304 and may be stored in other memory accessible to the processor 302 or distributed among several media, such as the data storage 306.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for routing messages through a secure messaging platform, the method comprising:
receiving, at a smart router, a request to send a message to at least one recipient;
routing, via the smart router, the request to a marketplace of delivery aggregators;
selecting at least one of the delivery aggregators for handling the request; and
delivering, via the selected at least one delivery aggregator, the message to the at least one recipient.

2. The computer-implemented method of claim 1, wherein the message comprises an SMS message.

3. The computer-implemented method of claim 1, further comprising:
training a machine learning algorithm to select the delivery aggregator.

4. The computer-implemented method of claim 1, wherein the routing is based at least in part on a multi-armed bandit selection paradigm.

5. The computer-implemented method of claim 1, wherein the selecting is based at least in part on message delivery cost and quality considerations.

6. The computer-implemented method of claim 1, wherein the message is sent for verification around the world.

7. The computer-implemented method of claim 1, wherein the message is routed to a service provider having a cheapest rate and high efficiency.

8. The computer-implemented method of claim 1, further comprising:
sending the request to the selected at least one delivery aggregator.

9. The computer-implemented method of claim 1, wherein the secure messaging platform is end-to-end encrypted.

10. The computer-implemented method of claim 1, wherein the delivery aggregators have different success rates in different telecommunications networks.

11. A system configured for routing messages through a secure messaging platform, the system comprising:
one or more hardware processors configured by machine-readable instructions to:
receive, at a smart router, a request to send a message to at least one recipient;
route, via the smart router, the request to a marketplace of delivery aggregators;
select at least one of the delivery aggregators for handling the request; and
deliver, via the selected at least one delivery aggregator, the message to the at least one recipient.

12. The system of claim 11, wherein the message comprises an SMS message.

13. The system of claim 11, wherein the one or more hardware processors are further configured by machine-readable instructions to:
train a machine learning algorithm to select the delivery aggregator.

14. The system of claim 11, wherein the routing is based at least in part on a multi-armed bandit selection paradigm.

15. The system of claim 11, wherein the selecting is based at least in part on message delivery cost and quality considerations.

16. The system of claim 11, wherein the message is sent for verification around the world.

17. The system of claim 11, wherein the message is routed to a service provider having a cheapest rate and high efficiency.

18. The system of claim 11, wherein the one or more hardware processors are further configured by machine-readable instructions to:
send the request to the selected at least one delivery aggregator.

19. The system of claim 11, wherein the secure messaging platform is end-to-end encrypted, and wherein the delivery aggregators have different success rates in different telecommunications networks.

20. A non-transient computer-readable storage medium having instructions embodied thereon, the instructions being executable by one or more processors to perform a method for routing messages through a secure messaging platform, the method comprising:
receiving, at a smart router, a request to send a message to at least one recipient;
routing, via the smart router, the request to a marketplace of delivery aggregators;
selecting at least one of the delivery aggregators for handling the request; and
delivering, via the selected at least one delivery aggregator, the message to the at least one recipient.
